(19) United States
(12) Patent Application Publication
(10) Pub. No.: US 2025/0298233 A1
(43) Pub. Date: Sep. 25, 2025

(54) Microscope

(71) Applicant: Carl Zeiss Microscopy GmbH, Jena (DE)

(72) Inventors: Jakob Haarstrich, Jena (DE); Alexander Scheps, Adelebsen (DE); Ralph Lange, Jena (DE); Philipp Holz, Jena (DE)

(21) Appl. No.: 19/083,884

(22) Filed: Mar. 19, 2025

(30) Foreign Application Priority Data
Mar. 24, 2024 (DE) 10 2024 108 373.5

(51) Int. Cl. G02B 21/26; G02B 21/36

(52) U.S. Cl. CPC G02B 21/26; G02B 21/362

(57) ABSTRACT

A microscope having a microscope optics unit, with two independent lateral spatial directions defined by an optical axis thereof, having a sample stage, an xy-drive for moving the sample stage in the lateral spatial directions, a holding frame arranged on the sample stage, wherein the holding frame is able to take evasive action in the lateral spatial directions, at least via finite-length evasive paths in each case, a control unit, at least for controlling the xy-drive, and an installation space model stored in the control unit and in which geometries and positions of the holding frame and of further components of the microscope are in each case at least partially captured as parameters that specify a collision space for displacement positions of the xy-drive. The evasive paths are so long that collisions between the holding frame and the further components that cause damage to colliding pieces cannot occur at displacement positions of the xy-drive.

The current application claims the benefit of German Patent Application No. 10 2024 108 373.5, filed on Mar. 24, 2024, which is hereby incorporated by reference.

The invention relates to a microscope according to the preamble of claim 1. A generic microscope comprises at least the following constituent parts: a microscope stand and a microscope optics unit, with an axial spatial direction and two independent lateral spatial directions being defined by an optical axis of the microscope optics unit and pieces of the microscope optics unit being able to be attached to the microscope stand, a sample stage attached to the microscope stand, an xy-drive for moving the sample stage in the lateral spatial directions, a holding frame serving to hold a sample and arranged on the sample stage, wherein, from an intended position relative to the sample stage, the holding frame is able to take evasive action in the lateral spatial directions, at least via finite-length evasive paths in each case, without damaging pieces that are in contact, a control unit, at least for controlling the xy-drive, and an installation space model which is stored in the control unit and in which geometries and positions of the holding frame and of further components of the microscope are in each case at least partially captured as parameters, wherein these parameters and a finite accuracy, with which they are captured in the installation space model, specify a collision space for displacement positions of the xy-drive, with collisions of the holding frame with the further components of the microscope being possible in said collision space.

Modern modular microscopes usually comprise a sample stage that can be displaced laterally, in a manner driveable by motor or actuatable by hand. Such sample stages, which are also referred to as xy-displacement stages, can be used to displace a sample laterally in order to bring the desired regions of the sample into a field of view of the microscope optics unit. Since these microscopes are used to examine very different samples, holding frames are used for adaptation to the comparatively expensive sample stages. Suitable rests and/or receptacles for the respective samples or sample carriers are provided in each case by way of suitably adapted holding frames, wherein one and the same sample stage may be used in each case.

As regards the design of the interface between a sample stage and a holding frame, the aspect of stability should be considered first. The connection between the sample stage and the holding frame should be so stable that it is insensitive to vibrations and drifts and that, moreover, a position of the holding frame relative to the sample stage is easily reproducible following the removal and reinstallation of the holding frame. Furthermore, the interface should be easily usable, to such an extent that the holding frame can easily be installed and removed by a user. There is a certain amount of conflict between the requirements of stability on the one hand and simple usability on the other hand.

The holding frame may be screwed to the sample stage. On the one hand, this achieves great stability and also good reproducibility of the position of the holding frame relative to the sample stage, with installation and removal, by contrast, being quite complicated. It is also considered disadvantageous that in the event of collisions with other microscope components, for example with a microscope objective, there may be damage to the components. Affixing the holding frame relative to the sample stage with the aid of springs or magnets is also known. These forms of affixment facilitate the installation and removal and, in principle, are also suitable for avoiding damage to components, at least for some spatial directions.

Finally, DE 20 2017 006 898 U1, DE 10 2016 125 691 B4 and DE 10 2017 120 651 B3 have disclosed complicated solutions in which forces that arise between a microscope slide and the holding frame, between an objective and the stand and between a sample stage and the stand can be registered with the aid of force and pressure sensors.

A problem addressed by the present invention can be considered that of specifying a microscope in which the holding frame is arranged stably and, at the same time, flexibly on the sample stage, and the risk of damage to the components as a result of collisions is reduced.

This problem is solved by the microscope having the features of claim 1.

According to the invention, the microscope of the type specified above is developed in that the evasive paths, via which the holding frame can take evasive action in the lateral spatial directions and away from its intended position, are so long that collisions that are between the holding frame and the further components of the microscope and that cause damage to colliding pieces cannot occur at displacement positions of the xy-drive in the collision space.

Advantageous configurations of the microscope according to the invention are explained below, especially in the context of the dependent claims and the figures.

Initially, the invention has recognized that although technical solutions in which collisions between components of the microscope and damage to the same are avoided by virtue of actuators present being stopped before a collision and/or damage to these components arises are desirable from the view of application, these solutions are linked to significant technical outlay and high costs because they necessarily require an active sensor system.

Moreover, the invention has recognized that contact between components need not be prevented absolutely for many applications; instead, it is sufficient to take up measures that prevent damage to components in the event of unintended contact between these components. In other words, the invention has recognized that contact between components can be allowed if suitable further technical measures are taken up.

In this context, the invention has also recognized that a non-fixed connection should be introduced on at least one of the components such as objective and sample stage and/or holding frame potentially coming into contact with one another, and this non-fixed connection should yield to such an extent when a force acts that no damage arises.

In principle, a non-fixed connection may be provided on the objective side. For example, this is implemented on objective changers which may be in the form of linear changers or as objective turrets. In the event of contact, the objective can take evasive action in the direction in which the objective changer is moved for the purpose of changing an objective, and consequently in the direction in which a linear changer is moved or an objective turret is rotated, and the connection between objective and stand is not fixed in this sense. Otherwise, consideration should however be given to the fact that any impairment in the connection between objective and stand has an influence on the relative pose of the objectives with respect to the beam path and consequently has an influence on the optical imaging quality. Providing further degrees of freedom of movement on part of the objective beyond the intended degrees of freedom of movement of objective changers, in such a way that the optical properties do not suffer at the same time, therefore tends to be complicated and disadvantageous. For example, a corresponding mechanical interface in an objective turret would have to be embodied separately for each objective.

Finally, the invention has also recognized that it is advantageous to provide a non-fixed connection on the sample side, namely between the sample stage and the holding frame.

An advantage obtained as a result of the invention is that damage to the components can be largely avoided. Moreover, an advantage that can be obtained in embodiment variants is that complete return to the intended position without manual user intervention is possible in the case of small deflections from the intended position.

The solutions of the invention require only a few additional components and can therefore be potentially implemented in cost-effective fashion. Furthermore, these passive solutions are available instantaneously and not subject to any constraints of the system, for instance reaction times to sensor signals. In particular, they do not depend on the proper functioning of other components, for example sensors, and are very failsafe overall.

The term installation space model should mean, in particular, a parameter set that contains at least some of the geometric dimensions of the components installed in the relevant microscope, optionally the current relative arrangements of these components and the mechanical manipulation options for the components. For example, mechanical manipulation options are options for rotating an objective turret, displacement paths of an xy-sample stage, but in particular also the adjustment options for a holding frame relative to the sample stage. The installation space model may also be considered to be a three-dimensional digital model of the microscope.

This makes it clear that the installation space model is different on an individual basis for every different configuration of the microscope system. At least severe malpositioning of the components in the space in the vicinity of the sample may be precluded from the outset on the basis of a configuration-based installation space model. The installation space model may also serve to determine respective evasive paths required such that the components cannot be damaged.

In preferred exemplary embodiments of the microscope according to the invention, the further components of the microscope, whose geometries and positions are in each case at least partially captured in the installation space model, comprise at least one or more or all of the following components: pieces of the microscope optics unit, pieces of illumination devices.

An essential concept of the present invention can be considered to be that the holding frame is arranged on the sample stage in such a way that it can take evasive action in both positive and negative directions in the lateral directions and, in preferred exemplary embodiments, in the positive direction in the axial direction, away from its intended position, in the event of contact with another component of the microscope, for example in the event of contact with an objective.

Moreover, an important concept of the invention is that the evasive paths that allow the holding frame to take evasive action without damage in the event of collisions, i.e. in the event of force acting on the holding frame, are chosen to be so long that as little play as possible is given away in view of the displacement positions of the xy-stage and optionally of a z-drive. Thus, the evasive paths are chosen to be so long that there cannot be such contact between the holding frame and one of the microscope components that the holding frame or one of the microscope components is damaged. Suitable dimensioning of the evasive paths can also preclude injury to the user, bruising of the fingers in particular being thought of in this case.

The invention makes allowances for safe navigation when moving the components of the microscope relative to one another, the need for which is growing with increased automation of the microscopes. In particular, use of the invention described here on the microscope can ensure that components moved relative to one another cannot be damaged during the relevant application.

As a rule, the components moved relative to one another are the objectives, an optionally present objective changer, for example an objective turret, on the one hand, and the sample stage and the holding frame for the sample, on the other hand.

A particularly preferred exemplary embodiment of the microscope according to the invention is distinguished in that a z-drive for adjusting an axial distance between the sample stage and the microscope optics unit is present, wherein the control unit is also configured to control the z-drive, in that from its intended position relative to the sample stage, the holding frame is able to take evasive action in the positive direction in the axial spatial direction, at least via a finite-length evasive path, without damaging pieces that are in contact, in that the parameters of the installation space model and the finite accuracy, with which they are captured in the installation space model, specify a collision space for the displacement positions of the xy- and the z-drive, with collisions of the holding frame with the further components of the microscope being possible in said collision space, and in that the evasive path, via which the holding frame can take evasive action in the positive axial spatial direction and away from its intended position, is so long that collisions that are between the holding frame and further components of the microscope and that cause damage to colliding pieces cannot occur at displacement positions of the z-drive in the collision space. Especially in the case of inverted microscopes, in which the holding frame is arranged above the microscope objective, the positive axial spatial direction means the direction away from the microscope objective. The term collision-free region in this case refers to those displacement points of the xy-drive and/or of the z-drive, at which collisions between the holding frame and other components of the microscope are not possible when the holding frame is in the intended position on the sample stage.

By preference, a shortest distance between points in a collision-free region and points outside of the collision space may be shorter than each of the lateral evasive paths of the holding frame. Likewise, a shortest distance between points in a collision-free region and points outside of the collision space may be shorter than the axial evasive path of the holding frame in the positive axial direction.

Accordingly, it may also be advantageous if in the intended position in the two lateral spatial directions, the holding frame is in each case in an at least partially reversible frictional engagement with the sample stage, said frictional engagement being configured to move the holding frame back into the intended position, at least in the event of deflections from the intended position that are in each case smaller than a reversible evasive path, and that in the event of deflections that are greater than the respective reversible evasive paths, restoring forces on the holding frame in the direction of the intended position do not grow with increasing deflection up to the end of the respective evasive path.

In general, the axial spatial direction might be identical to the direction of the gravitational force. However, this is not necessary.

A further preferred exemplary embodiment of the microscope according to the invention is distinguished in that in the intended position in the axial spatial direction, the holding frame is in an at least partially reversible frictional engagement with the sample stage, said frictional engagement being configured to move the holding frame back into the intended position in the event of deflections from the intended position that are smaller than a reversible axial evasive path, and in that in the event of deflections that are greater than the reversible axial evasive path, restoring forces on the holding frame in the direction of the intended position do not grow with increasing axial deflection up to the end of the axial evasive path.

In this exemplary embodiment, the arrangement of the holding frame on the sample stage thus is mechanically designed in such a way that the holding frame returns to the intended position in the case of deflections from its intended position that are smaller than maximal deviations in each case, i.e. in the three coordinate directions, should the exertion of force on the holding frame, for example by way of an objective, be reduced or terminated. Typically, the maximal deflections may be a few mm in the three coordinate directions. In this sense, the frictional engagements between the holding frame and the sample stage are partially reversible. In this case, the restoring forces acting to return the holding frame into its intended position are advantageously designed such that they are smaller than forces that lead to damage to the holding frame, the sample stage or other components of the microscope.

In a further preferred exemplary embodiment of the microscope according to the invention, at least one of, or a plurality or all of the lateral evasive paths are longer than half of a respective lateral overall displacement path of the xy-drive and/or the axial evasive path is longer than half of the axial overall displacement path of the z-drive.

By preference, at least one of, a plurality of or all of the lateral evasive paths may also be longer than a respective lateral overall displacement path of the xy-drive and/or the axial evasive path may be longer than the axial overall displacement path of the z-drive.

It is finally also particularly preferable for a shortest distance between a point in a collision-free region and a point outside of the collision space to be shorter than each of the reversible evasive paths. The advantage achieved hereby is that the holding frame returns to its intended position after all collisions once the interfering effect has ended.

In advantageous configurations of the microscope according to the invention, the user is moreover able to obtain feedback should collisions have occurred. Following a collision, this facilitates complete re-establishment of the function of the system by way of as few user interventions as possible.

In the case of purely passive and consequently mechanical exemplary embodiments of the invention, feedback that a collision has occurred is not mandatory because the arrangement of the holding frame on the sample stage is configured in such a way according to the invention that no damage can occur on the holding frame, the sample stage or an objective. However, to increase user convenience, sensors that signal contact between components to the user, for example in acoustic and/or optical fashion, may be provided. For example, as explained in detail below, a measuring device may be present for the purpose of detecting a position of the holding frame relative to the sample stage. In an alternative to that or in addition, there may also be sensors present, by means of which forces that occur between the components, for example between a microscope objective and the holding frame and/or the sample stage and/or between the holding frame and the sample stage, can be measured and optionally displayed to a user. The measuring device (sensor system) may also offer the option of monitoring whether a holding frame has been inserted correctly. Finally, the measuring device is also able to detect whether the holding frame was displaced relative to the sample stage, which might indicate a collision, e.g. with an objective.

In this application, the term microscope stand should be understood to mean rigidly interconnected components, in particular housing components, which remain arranged in substantially unchanged fashion during the intended use of the microscope. For example, components of an illumination and/or components of a microscope optics unit may be present on or within the microscope stand. Moreover, components of a control unit and e.g. a power supply unit for providing power may be present in the microscope stand, which may also be referred to as a base. For example, the sample stage may be screwed to the microscope stand.

The microscope might be an upright microscope, in which the microscope objective is arranged above the holding frame with the sample. In preferred configurations, the microscope is an inverted microscope, i.e. the holding frame may be arranged above the microscope objective.

Microscope, characterized in that the holding frame is mounted in at least one frictional engagement, in particular at points in each case, and pressed in the direction of the holding frame by a fixing force.

The fixing force may be provided by one or more of the following types of force: gravitational force, magnetic force, spring force of a spring.

In particular depending on the type of components to be fixed relative to one another, for example depending on the type of sample carrier types to be fixed to the sample stage, the fixing force may be dimensioned such that no damage may occur on the components to be fixed relative to one another. In that case, the holding frame may rest on the sample stage, for example.

In a broad sense, the term microscope optics unit denotes all optical components such as objectives, filters, mirrors, lenses, polarizers, etc., by means of which a microscopic observation beam path is provided. Optionally, further optical components may be present for the purpose of providing an illumination beam path. In a narrower sense, the microscope optics unit should be understood to mean at least one microscope objective. At least one microscope objective is attached to the microscope stand, for example in an objective turret.

Typically, the sample stage may be an xy-displacement stage or else an xyz-displacement stage. This means that the sample stage can be displaced, independently in each case, in the directions of the x- and y-coordinates or in the directions of the x-, y- and z-coordinates, for example by way of accurate screw drives. The direction of the optical axis of the microscope objective is typically referred to as z-direction. From the view of a user seated in front of the microscope, the left-right direction is typically defined as x-direction. From the view of this user, the y-direction then is the forwards-backwards direction. The sample stage may comprise a cutout or a receptacle, in which the holding frame is received or on which it rests. The receptacle may define the intended position of the holding frame relative to the sample stage. For example, the receptacle may be formed by a depression in the sample stage. To allow passage of the optical detection beam path in inverted microscopes and, optionally, to provide a transmitted light or dark field illumination in the case of upright microscopes, the sample stage may comprise a suitable opening in which a sample to be examined may be positioned together with the holding frame.

The term holding frame should be understood to mean a mechanical arrangement that is able to receive typical sample carriers such as microscope slides or petri dishes and that is suitable for being connected to the sample stage in a defined manner.

Typically, both the sample stage and the holding frame substantially have the shape of rectangles, the sides of which are arranged substantially in parallel in the case of an intended working state.

However, this is not mandatory. For example, it would also be possible for the holding frame to have the shape of an annulus, which is received in a circular disc-shaped cutout in the sample stage.

For example, the holding frame may rest on the sample stage via at least one contact pin. The holding frame may advantageously rest on the sample stage by way of three contact pins in order to implement a three-point bearing. To facilitate movement of the holding frame relative to the sample stage, the end of the respective contact pin resting on the sample stage may be rounded-off in the case of at least one or more or all of the contact pins.

In a preferred exemplary embodiment, magnets for holding the holding frame against the sample stage may be present on the sample stage and/or on the holding frame. Moreover, the holding frame may comprise at least one ferromagnetic element for engagement with magnets on the sample stage, and/or the sample stage may comprise at least one ferromagnetic element for engagement with magnets on the holding frame.

In this context, at least one or more or all of the contact pins of a further exemplary embodiment may be at least partially magnetic or at least partially formed from a ferromagnetic material in order to engage with a magnet on the sample stage. For example, a tip of at least one contact pin may be manufactured to be magnetic or manufactured from a ferromagnetic material.

A particularly preferred variant is distinguished in that in the event of the intended orientation of the holding frame and of the sample stage relative to the direction of the gravitational force, the gravitational force brings about, or at least contributes to, the partially reversible frictional engagement for at least one coordinate direction, in particular for all three coordinate directions. Advantageously, in the event of the intended orientation of the holding frame and of the sample stage relative to the direction of the gravitational force, the gravitational force may bring about, or at least contribute to, the partially reversible frictional engagement in the direction of the optical axis of the microscope optics unit or else in all three coordinate directions.

In an alternative to that or in addition, mechanical devices may be present for creating the frictional engagement with a force driving back into the intended position.

In an advantageous development, the mechanical devices may comprise at least one mechanical guide for at least one contact pin. The at least one mechanical guide for a contact pin may comprise a dip that is introduced into the sample stage or may be formed thereby.

Advantageously, at least one dip may have a punctiform potential minimum for receiving a contact pin. Such a dip in that case defines exactly one intended position for the contact pin. Furthermore, at least one dip may have an extensive potential minimum in one coordinate direction, for receiving a contact pin. This allows the contact pin situated in such a dip to carry out a linear movement over a certain path length in the relevant coordinate direction.

Together with the contact pins, the dips may advantageously be configured to return the holding frame back into the intended position in the event of deflections, in each case smaller than reversible evasive paths, in the x- and/or y-direction away from the intended position.

These embodiment variants are completely passive, i.e. the partially reversible frictional engagement is brought about by the gravitational force in all three coordinate directions.

Should the contact pins leave the region of the dip and reach a substantially planar region of the sample stage, the restoring forces acting on the holding frame towards the intended position in the lateral directions optionally also reduce down to zero. The restoring force in the axial direction is provided by the gravitational force; it likewise does not increase as the holding frame increases its distance relative to the sample stage.

A respective friction-reducing material may be introduced between the at least one contact pin and a dip or between a plurality or all of the contact pins and the respective dip, or the region of the dip itself may be formed from a low-friction material, for example Teflon. In further advantageous configurations, the mechanical devices comprise at least one elastic component that presses the holding frame back into the intended position in the event of deflections from the intended position that are in each case smaller than reversible evasive paths or the reversible evasive paths. For example, the elastic components may comprise one or more of the following components: springs, leaf springs, clamps, elastic spacers, spacers made of foam-like material. The elastic components may be manufactured from metal and/or from plastics.

The elastic components must be suitably formed for the feature according to the invention whereby restoring forces, which act on the holding frame in the direction of the intended position in the event of deflections that are greater than the respective maximal deflections, do not grow with increasing deflection, at least beyond a value range of the deflections. Optionally, the elastic components need to be manually reinserted should the holding frame be removed from the intended position beyond the maximal deflections.

High-resolution microscopic methods require an exact alignment of the sample carrier perpendicular to an optical axis of an objective. This requires accuracies of down to less than 5 minutes of arc. The sample carriers may be the coverslip of a microscope slide, the base of petri dishes and/or the base of multiwell sample carriers. In an intended operational situation of the microscope, a normal direction of a main surface that can be associated with the holding frame will point substantially in the same direction as a surface normal of the sample stage. The term alignment of the holding frame relative to the sample stage means the manipulation of the angle between these two surface normals. In the present case, the term alignment does not mean a rotational position of the holding frame relative to the sample stage about an axis of rotation extending approximately in the direction of the aforementioned surface normals. A rotational position of the holding frame relative to the sample stage about the aforementioned axis of rotation is substantially defined by suitable receiving means in the sample stage, for example a depression. The procedure of setting the alignment of the holding frame relative to the sample stage is also referred to as levelling. The mechanical devices to this end, comprising levelling screws in particular, are referred to as levelling mechanisms. The term alignment of the holding frame relative to the sample stage in particular also comprise the angular position of the holding frame relative to the sample stage.

Advantageous configurations of the microscope according to the invention consequently comprise a levelling mechanism for setting an alignment of the holding frame relative to the sample stage. In particular, setting means may be present for setting an alignment of the holding frame relative to the sample stage. The setting means may be configured to set a height of the holding frame relative to, in particular above, the sample stage.

The setting means comprise at least one levelling screw in a preferred exemplary embodiment. For example, at least one of the contact pins may be a settable levelling screw or a plurality or all of the contact pins may be settable levelling screws. Advantageously, three levelling screws are present for the purpose of providing a three-point manipulation. To provide tilt along two orthogonal axes, two independently settable levelling screws are also sufficient.

In principle, servomotors may be present for setting the setting means, in particular the levelling screws; although this provides user convenience, it is comparatively complicated. The setting means may be manually settable in less complicated configurations. The setting means may also comprise controllable piezo-actuators. For example, piezo-actuators, by means of which a fine adjustment of a height position can be performed, may be arranged between the sample stage and the levelling screws.

In further particularly preferred variants of the invention, a measuring device is present for detecting the alignment of the holding frame relative to the sample stage. Specifically, the measuring device may be configured to detect an angular position of the holding frame in relation to two axes of rotation that are perpendicular to one another and in each case extend perpendicular to an optical axis of a microscope objective. The measuring device may also serve and be configured to measure a relative position of the holding frame and/or of the sample stage relative to the microscope stand. Particularly preferably, the measurement data are supplied to the installation space model. This can improve the accuracy of the installation space model, and so shorter evasive paths are sufficient.

For example, the measuring device may be configured to determine the distance of in each case three defined points on the holding frame from a surface of the sample stage. In particular, the measuring device may advantageously be configured to determine the distance of in each case the locations at which levelling screws are situated from a surface of the sample stage.

In a further particularly preferred exemplary embodiment, the measuring device is configured to directly detect an angular position of the holding frame relative to the sample stage. To this end, the measuring device may comprise at least one optical sensor that is configured to determine a distance of a point on a surface of the holding frame relative to the sample stage or the microscope stand. In particular, the optical sensor may be configured to measure a height coordinate of at least one point on the holding frame. The optical sensor may be a sensor operating on interferometric principles, a triangulation sensor or a sensor that measures a phase offset between transmission and reception beam. Advantageously, three distance-measuring optical sensors may be present in order to implement a three-point measurement.

The optical sensors may be arranged rigidly relative to the sample stage or relative to the microscope stand. In advantageous variants, the optical sensors may be arranged on the microscope stand and irradiate defined points on the holding frame. Should the optical sensors be arranged on the stand, knowledge of the relative position between sample stage and stand is required to ascertain the relative position between holding frame and sample stage; this generally is the case.

However, it is also possible to perform measurements sequentially using only a single sensor. To this end, it is necessary to modify the target location of the sensor on the holding frame between the measurements. This could be achieved by pivoting the sensor; however, this appears complicated. A target location of the sensor on the holding frame can be modified comparatively easily between the measurements by virtue of the xy-displacement stage being suitably actuated and hence the holding frame being displaced relative to the sensor. A precondition for this is that the sensor is rigidly connected to the stand and not rigidly connected to the sample stage.

In a particularly preferred exemplary embodiment, the measuring device is configured to indirectly detect an angular position of the holding frame relative to the sample stage by detecting a setting of the setting means. Thus, in these variants, a measurement is performed not on the holding frame but on the setting means instead. For example, the measuring device may comprise one or more cameras.

Furthermore, an alignment of the holding frame may also be ascertained by observing a reference mark on the holding frame using a camera and evaluating the camera image. This observation may be implemented via the microscope objective, and an overview camera of the microscope system may also be used to this end. In this case, the measuring device according to the invention is implemented by the microscope system itself. In this case, it is also possible to use a sample finder camera which uses artificial intelligence to monitor the relative position between the holding frame and the sample stage.

Finally, the measuring device may be configured to determine not only the alignment of the holding frame relative to the sample stage but also, in particular together with the control unit, a distance of the holding frame from a surface of the sample stage.

Should magnets be present for fixing the holding frame relative to the sample stage, the measuring device may advantageously also comprise one or more magnetic distance sensors, by means of which it is possible to measure a relative position of the holding frame relative to the sample stage, as an alternative to the optical sensors, such as cameras or optical distance sensors, or in addition to them. In particular, comparatively small displacements of the holding frame may be detected easily by magnetic distance sensors.

In order to reduce wiring outlay, the sensors that are used may comprise wireless interfaces for data and power transmission.

In order to obtain reliable information about a setting state of a levelling screw, at least one of the levelling screws in a preferred configuration has a marking for the detection of the respective rotational position of said levelling screw. Particularly preferably, the marking comprises a marking element or a plurality of marking elements. It is also advantageous if at least one of the marking elements, preferably all of the marking elements, is or are detectable, in particular optically detectable, by scanning with electromagnetic radiation. More accurate monitoring of a setting state, for example of a levelling screw, can be achieved if a plurality of marking elements are present and if the marking elements comprise physically different features, by way of which they are distinguishable by the measuring device. For example, the physically different features may be formed by at least one of the following features: different geometric dimensions, different geometric shapes, different hatching, different colours.

In a comparatively simple configuration, the levelling screws may each have markings, from which the rotational position of the levelling screws can be read, on the top sides of their screw heads. This variant is preferable, in particular, if an entire travel of the levelling screws is completed within a single rotation. Then, detecting the marking supplies unambiguous information about the setting state of the relevant levelling screw.

For example, the marking may comprise at least one marking element attached to a top side of a screw head of the levelling screw. For example, this marking element may be a radially extending watch hand-like mark. It is self-evident that variations are possible. All that is important is that the embodiment of the marking is such that observation thereof supplies information about the setting of the levelling screw.

In an alternative to that or in addition, marking elements may be attached to an edge of the screw head of the levelling screw. For example, a plurality of marks extending in the axial direction may be present as marking elements on an edge of the screw head of the levelling screw. Advantageously, the marking elements may be attached at equal intervals in a circumferential direction on an edge of the screw head.

In an alternative to that or in addition, at least one marking element of the marking may be attached to a shank of a levelling screw at a defined height in a further advantageous configuration. This variant is preferable as an addition, in particular, if an entire travel of the levelling screws is completed over more than one rotation or a plurality of rotations of the levelling screws, i.e. if the detection of markings on the screw head cannot supply unambiguous information about the setting state of the relevant levelling screw. For example, a levelling screw may have at least one marking that is situated on its thread and allows a relative position of the relevant levelling screw relative to the holding frame to be read. In this case, the marking element may be a ring that extends around the shank of the levelling screw in the circumferential direction. Advantageously, a plurality of marking elements may also be attached to a shank of at least one levelling screw. For example, these may be attached at equal intervals in the direction of extent of the shank.

Settings of the setting means required to obtain a horizontal position of the holding frame may be stored in the control unit.

In reality, optical and mechanical tolerances of components often lead to deviations from the installation space model that are greater than the application which requires: Thus, e.g. in the axial direction, use is made of working distances of objectives that sometimes only equal 0.1 mm. This yields even more stringent requirements of e.g. 10 μm in relation to the model accuracy of the installation space model should the latter be configured to ensure collision-free navigation without significantly restricting the application. However, the installation space model may merely serve to determine the respective evasive paths required such that components cannot be damaged, or else that the reversible evasive regions are never departed. The latter case only requires model accuracies of the installation space model of the order of 1 mm; this can be achieved much more easily and cost effectively.

This means that the combination of the holding frame according to the invention with a preferably reversible evasive path with a configuration-based installation space model, which is stored in the control unit and which has a model accuracy better than the reversible evasive path, allows the construction of a microscope system in which microscope components are not damaged and, in the case of reversibility, there moreover is no need for a manual user intervention in the case of a collision. To date, this has only been possible using a sensor system or by restricting the imageable sample regions.

In contrast to previously known solutions, the present invention allows information obtained by the measuring device, for example the camera, to be stored in the installation space model and to be rendered usable in one workflow.

A set angular position determined by the measuring device and a distance and a position of the holding frame relative to the sample stage and/or to the stand may be communicated to the control unit and integrated in the installation space model. Hence information is available, from which e.g. disturbance contours or collision geometries can be derived using an installation space model, and consequently information is available regarding possible displacement paths or movement paths for the individual components that do not lead to collisions. In particular information for a user, for instance regarding functional limitations, may be generated on the basis of information regarding a holding frame that can be levelled, in particular levelled manually, and said information may be displayed to the user by way of the control unit.

For example, the ascertained alignment angles may be used in the control unit in order to display the set levelling angles to a user. Furthermore, in a given situation, the control unit may provide the user with instructions as to how a desired angle target position, e.g. a horizontal initial position of the holding frame (zero position), may be reached. The ascertained alignment angles may also serve to complement an installation space model stored in the control unit, or to make said installation space model more precise.

For example, a disturbance contour of the holding frame may be ascertained or made more precise within an installation space model, preferably a three-dimensional installation space model, of a space in the vicinity of the sample, and a collision-free displacement range of the holding frame or of other components may be updated and improved in terms of its accuracy.

Should the installation space model of the microscope system and consequently collision geometries be known, the control unit is able in particular to ensure that, in terms of the instructions to the user, there are no collisions or in any case no collisions that lead to component damage when the settings of the setting means are modified in accordance with the instructions.

Thereupon, the control unit can ascertain information regarding restrictions of workflows on the microscope system on the basis of limit values for the angles of the holding frame relative to the sample stage using measurement data from the measuring device and display said information to a user.

An important advantage for a user that can be achieved is that the control unit is able to output a unique workflow for setting a certain initial pose, e.g. a horizontal initial pose, of the holding frame.

A further important advantage is that a safe displacement range of the holding frame can be increased in a levelled state. In some cases, it is only this information that allows safe focusing of a sample in a correctly levelled state for microscope objectives with a small working distance.

The measurement data of the measuring device, consequently the camera or cameras, and/or of other optical sensors may be supplied to the control unit, and the control unit may be configured to output a warning signal, for example an optical and/or an acoustic warning signal, if there is a risk of collisions between the holding frame and other components of the microscope, for example an objective turret.

Further advantages and properties of microscopes according to the invention are explained below in association with the accompanying figures, in which:

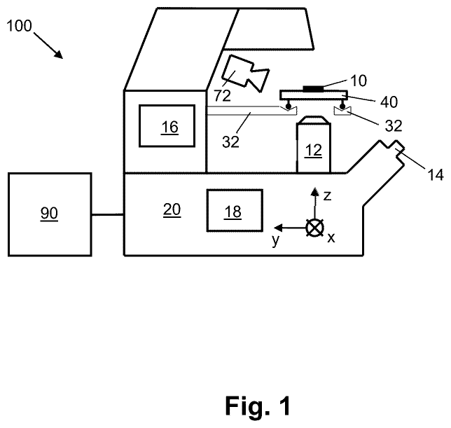

FIG. 1: shows a first exemplary embodiment of a microscope according to the invention;

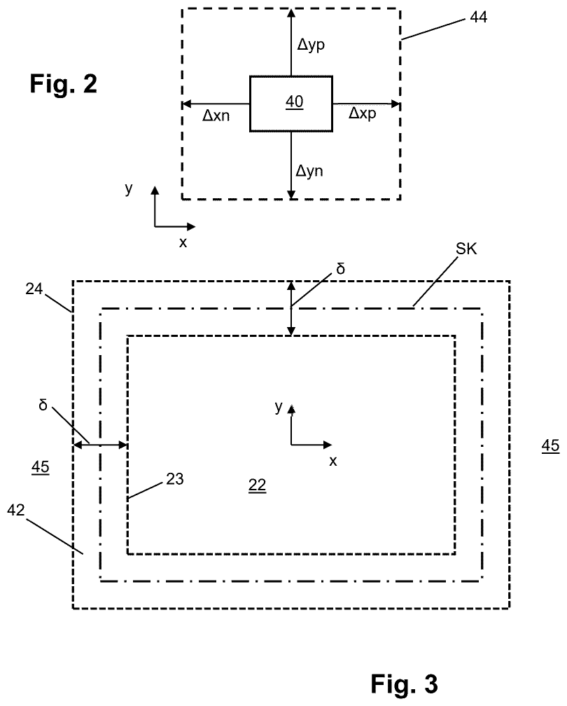

FIG. 2: shows a schematic illustration of the lateral evasive paths in the microscope according to the invention from FIG. 1;

FIG. 3: shows a schematic illustration of a collision space in the xy-plane;

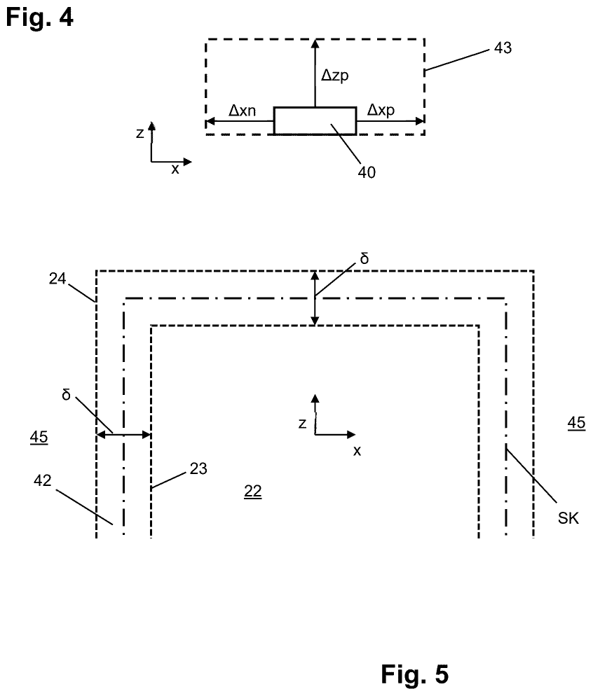

FIG. 4: shows a schematic illustration of an axial evasive path in the microscope according to the invention from FIG. 1;

FIG. 5: shows a schematic illustration of a collision space in the xz-plane for the microscope from FIG. 1;

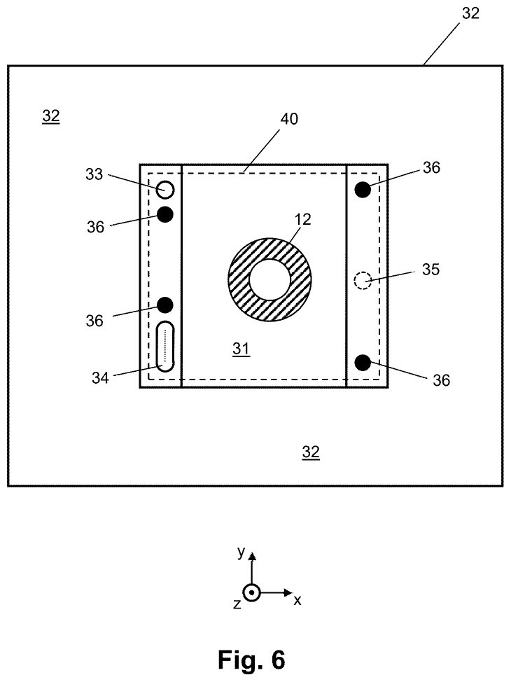

FIG. 6: shows a schematic plan view of the sample stage of the microscope from FIG. 1;

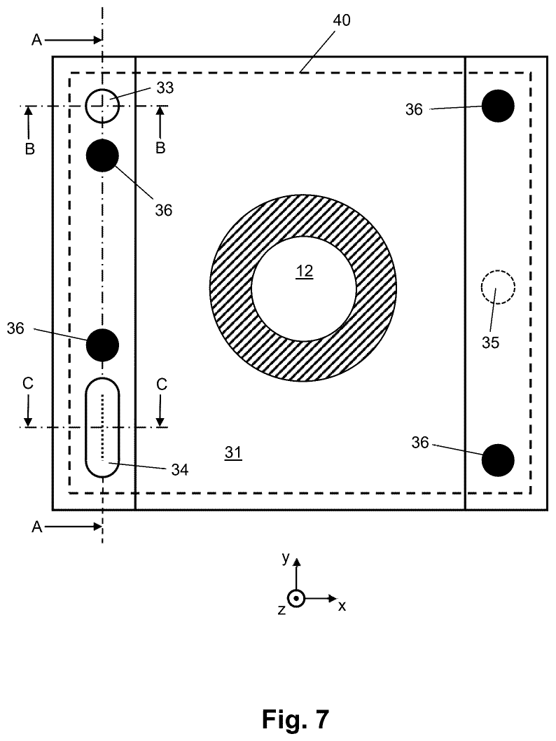

FIG. 7: shows a plan view of details of the sample stage in FIG. 6;

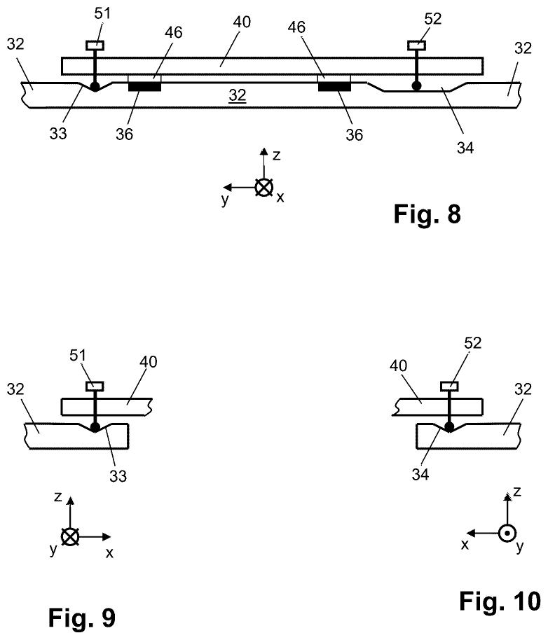

FIG. 8: shows a partial sectional view taken along the line A-A from FIG. 7;

FIG. 9: shows a partial sectional view taken along the line B-B from FIG. 7;

FIG. 10: shows a partial sectional view taken along the line C-C from FIG. 7;

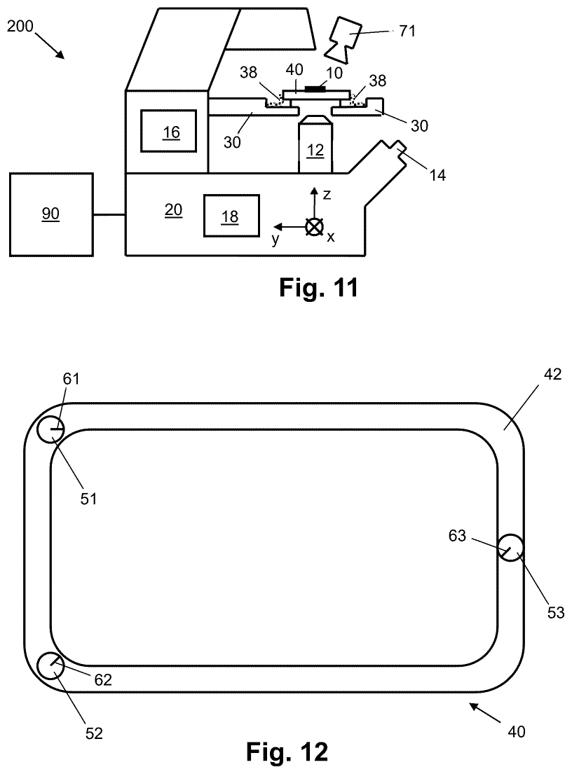

FIG. 11: shows a second exemplary embodiment of a microscope according to the invention;

FIG. 12: shows details of the holding frame 40 of the microscope from FIG. 1;

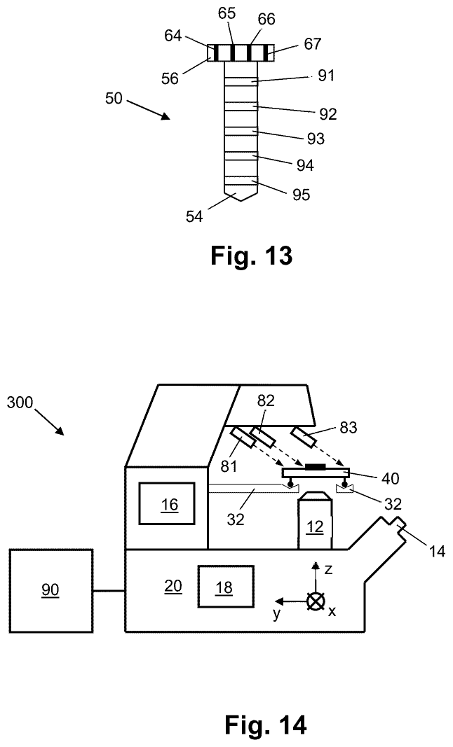

FIG. 13: shows an exemplary embodiment of a levelling screw for a holding frame for a microscope according to the invention; and

FIG. 14: shows a third exemplary embodiment of a microscope according to the invention.

Components that are the same or act in the same way are generally characterized by the same reference signs in the figures.

A first exemplary embodiment of a microscope 100 according to the invention will be explained in conjunction with FIGS. 1 to 10. The microscope 100 according to the invention depicted schematically in FIG. 1 is an inverted microscope, i.e. the microscope optics unit 12 views the sample 10 from below. According to the invention, the microscope 100 initially comprises a microscope stand 20, on which pieces of a microscope optics unit 12 and a sample stage 32 are attached in the example shown. For example, the sample stage 32 may be a xy-displacement stage. In FIG. 1, the microscope optics unit is depicted schematically as microscope objective 12.

An axial spatial direction z and two mutually independent lateral spatial directions x, y are defined by an optical axis of the microscope optics unit, of the microscope objective 12 in the present case. The optical axis of the microscope objective 12 extends in the z-direction. The coordinate system defined thus is shown in FIG. 1, with the positive x-direction extending into the plane of the drawing, the positive y-direction extending to the left and the positive z-direction extending upwards. According to the invention, a holding frame 40 that is arranged on the sample stage 30 and serves to hold a sample 10 is present.

In the situation depicted in FIG. 1, the holding frame 40 is in an intended position relative to the sample stage 32. According to the invention, the holding frame 40 is deflectable in this intended position relative to the sample stage 32, in each case in the positive and negative direction in the lateral spatial directions x, y and in the positive direction in the axial spatial direction z. Deflections of the holding frame 40 from the intended position relative to the sample stage 32 in the lateral spatial directions x, y are denoted by Δx and Δy, respectively. A deflection of the holding frame 40 from the intended position relative to the sample stage 32 in the axial spatial direction z is denoted by Δz. Δx and Δy may adopt positive and negative values, Δz may only adopt positive values because the holding frame 40 rests on the sample stage 32 in the example shown.

The sample stage 32 contains an opening 31 (without reference sign in FIG. 1), through which the microscope objective 12 sees a sample 10 arranged on the holding frame 40.

Reference sign 14 denotes a schematically shown eyepiece for a user.

FIG. 2 schematically shows the lateral evasive paths for the holding frame 40 of the microscope 100 from FIG. 1. It is evident that the holding frame 40 can take evasive action up to a distance Δxp in the positive x-direction and up to a distance Δxn in the negative x-direction, without colliding components being damaged. The holding frame 40 can take evasive action up to a distance Δyp in the positive y-direction and up to a distance Δyn in the negative y-direction, without colliding components being damaged. A contour of the region spanned by the lateral evasive paths is labelled by reference sign 44 in FIG. 2.

FIG. 3 schematically shows regions for displacement points of the xy-drive. An inner region 22 is distinguished in that there cannot be any collisions between the holding frame 40 and other components of the microscope when the holding frame 40 is situated in the intended position on the sample stage 32 and the settings of the xy-drive are located in the region 22. The region 42 referred to as collision space 42 is distinguished in that, based on the model and within the scope of the model accuracy, collisions between the holding frame 40 and further microscope components are possible but not unavoidable in this region should the holding frame 40 be in its intended position on the sample stage 32 and the xy-displacement stage assume positions in the region 42. In the event of positions of the xy-displacement stage outside of the region 42, i.e. in the region 45, there unavoidably are, based on the model and within the scope of the model accuracy, collisions between the holding frame 40 and other microscope components.

In FIG. 3, the collision space 42 is rectangular with sides that are parallel to the coordinate directions. That is to say, the lateral boundaries of the collision space 42 in the x-direction are independent of those in the y-direction. However, this need not be the case. That is to say, the collision space may also have a shape which deviates from the rectangular shape shown in FIG. 3 and in which the lateral boundaries in the x-direction depend on those in the y-direction, and vice versa.

The region 42 contains a nominal disturbance contour SK that is given by data stored in the installation space model in regard to the geometry and position of the holding frame and adjacent components of the microscope, for example components of the microscope optics unit or an illumination, with which the holding frame 40 may possibly collide, to be precise supposing ideal accuracy of these data.

In practice, however, these data are only known with finite accuracy, for example on account of material tolerances or manual malpositioning of the holding frame 40 and/or on account of deviations of actual positions of the xy-table from the control signals for the xy-table.

The distance δ is the shortest distance from a point in the collision-free region 22 to a point outside of the collision space 42. The distance δ depends directly on the finite accuracy with which the data of the installation space model are known. This accuracy can be increased, and consequently the distance δ can be reduced, if a position and an alignment of the holding frame 40 are measured, for example using the camera 72 in FIG. 1, and the measurement data are supplied to the installation space model. Examples in this respect are explained below. The greater the accuracy of the installation space model, the shorter the distance δ and also the shorter the evasive paths for the holding frame that need to be kept available.

According to the invention, the lateral evasive paths Δxp, Δxn, Δyp, Δyn (see FIG. 2), via which the holding frame 40 can take evasive action in the lateral spatial directions and away from its intended position, are so long that collisions that are between the holding frame 40 and the further components of the microscope and that cause damage to colliding pieces cannot occur at displacement positions of the xy-drive in the collision space 42.

In the exemplary embodiment shown, the lateral evasive paths Δxp, Δxn, Δyp, Δyn are in particular greater than the shortest distance δ from a point in the collision-free region 22 to a point outside of the collision space 42. A control unit 90 (see FIG. 1) can preferably be set up to move the x-y table 32 only in the region 22 and in the collision space 42 in order to avoid collisions that could cause damage.

For the holding frame 40 of the microscope 100 from FIG. 1, FIG. 4 schematically shows the lateral evasive paths Δxp, Δxn in the x-direction and, moreover, an axial evasive path Δzp in the positive z-direction. In the positive z-direction, the holding frame 40 can take evasive action up to a distance Δzp. Since the holding frame 40 rests on the sample stage 32, said holding frame cannot take evasive action without damage in the negative z-direction.

FIG. 5 schematically shows regions for displacement points of the xy-drive and the z-drive. In the shown example of an inverted microscope, the sample stage is immovable in the z-direction, and the z-drive can be used to adjust the axial height of the objective 12. The z-coordinate should represent the axial height of the objective 12. Like in FIG. 3, there cannot be any collisions between the holding frame 40 and other components of the microscope in the inner region 22 when the holding frame 40 is situated in the intended position on the sample stage 32 and the settings of the xy-drive and of the z-drive are located in the region 22. Just like in FIG. 3, collisions between the holding frame 40 and further microscope components are possible but not unavoidable in the region 42 referred to as collision space 42 should the holding frame 40 be in its intended position on the sample stage 32 and the xy-displacement stage and the z-drive assume positions in the region 42. There unavoidably are collisions between the holding frame 40 and other microscope components in the event of positions of the xy-displacement stage and the z-drive outside of the region 42, i.e. in the region 45.

In principle, the z-drive and consequently the objective 12 may be driven downwards as far as a stop. There is no risk of a collision for the holding frame 40 in this direction.

In a manner comparable to the situation in FIG. 3 for the x- and the y-coordinate direction, the lateral boundaries of the collision space 42 in the x-direction are independent of those in the z-direction in FIG. 5. However, this is not mandatory. The collision space may also have a shape which deviates from the shape shown in FIG. 5 and in which the lateral boundaries in the x-direction and/or in the y-direction depend on those in the z-direction, and vice versa.

In the exemplary embodiment of FIG. 1, the holding frame 40 in the intended position is also in a respective at least partially reversible frictional engagement with the sample stage 32 in each of the two lateral spatial directions x, y and the axial spatial direction z. This respective at least partially reversible frictional engagement is in each case configured to move the holding frame 40 back into the intended position, at least in the event of deflections Δx, Δy, Δz from the intended position that are in each case smaller than a maximal deflection Δxmax, Δymax, Δzmax.

In the example shown, this at least partially reversible frictional engagement is achieved by contact pins 51, 52 mounted in dips 33, 34; this is only shown schematically in FIG. 1 and explained in detail below in the context of FIGS. 6 to 10.

Finally, according to the invention, in the event of deflections that are greater than the respective maximal deflections Δxmax, Δymax, Δzmax, the restoring forces on the holding frame 40 in the direction of the intended position are configured such that they do not grow with increasing deflection, at least beyond a value range of the deflections Δx, Δy, Δz.

In the example of FIG. 1, the restoring force in the direction of the intended position for the axial spatial direction z is provided by the gravitational force acting in the direction of the negative z-axis and by magnetic forces; this will also be described in more detail in the context of FIGS. 6 to 10. However, the magnets are not required to implement the invention.

Consequently, should the holding frame 40 be lifted so far upwards off the sample stage 32 that the magnetic forces become weaker, the axial restoring force reduces to the value of the gravitational force. Then, the holding frame 40 can move practically freely in this sense within the value range of the axial displacements, up to the microscope stand 20 in the upward direction.

Furthermore, in the example of FIG. 1, the restoring forces on the holding frame 40 in the direction of the intended position will reduce in the two lateral spatial directions x, y should the contact pins 51, 52 be moved out of the region of the dips 33, 34 (see FIGS. 8 to 10). Should the holding frame 40 be at a sufficient distance from the intended position and hence should the magnetic forces have dropped off as well, the lateral restoring forces will be close to zero. Then, the holding frame 40 can move practically freely in this sense within the value range of the lateral displacements, up to the microscope stand 20.

FIG. 6 shows the sample stage 32 from above. FIG. 7 shows that portion of the sample stage 32 in which the holding frame 40 is received in the intended position. In each of FIGS. 6 and 7, the holding frame 40 is only depicted schematically by way of its outer contour. Furthermore, FIGS. 6 and 7 moreover schematically show the opening 31 in the sample stage 32 and the microscope objective 12 situated therebelow. A dip 33 with a punctiform potential minimum, a dip 34 with an elongate potential minimum and a plane support surface 35 are formed in the sample stage 32. In its proper intended position, the holding frame 40 rests in the first dip 33 with a first contact pin 51, in the second elongate dip 34 with a second contact pin 52 and (only shown in FIG. 12) on the support surface 35 with a third contact pin 53. A three-point bearing which unambiguously defines the intended position of the holding frame 40 vis-à-vis the sample stage 32 is implemented by the first contact pin 51, the second contact pin 52 and the third contact pin 53. Magnets 36 that interact with ferromagnetic elements 46, which are arranged on the holding frame and may be referred to as counter pieces (see FIG. 8), are present on the sample stage for the purpose of holding the holding frame 40 against the sample stage 32 in the shown exemplary embodiment.

The holding force of the magnets 36 is dimensioned such that collisions along all three axes never give rise to forces that are greater than other weak points in the system, e.g. the click-stop mechanism of the objective turret, a spring on the objective front, and so certain predetermined sample carrier types cannot be damaged (e.g. by coverslips breaking). This ensures that the non-fixed connection is always and reliably used, the latter being provided by the arrangement of the contact pins 51, 52 in the dips 33, 34 and the magnetic fixation implemented by the magnets 36 and counter pieces 46. In that case, this force may be specified concretely in newtons, e.g. 5 newtons.

To facilitate sliding in the dip 33 (contact pin 51) or 34 (contact pin 52), the contact pins 51 and 52 of the shown example have a flattened, e.g. spherical, support end. Respective mechanical guides for the contact pins 51 and 52 are provided by the dips 33 and 34.

From FIGS. 8 to 10, it is evident that, in the event of lateral deflections of the holding frame 40 relative to the sample stage 32 in which the first contact pin 51 does not move out of the dip 33 and the second contact pin 52 does not move out of the dip 34, the holding frame 40 is moved back into the intended position by the effect of the dips 33 and 34 as a mechanical guide in each case and by the effect of the gravitational force, which presses the contact pins 51 and 52 back into the potential minima of the dips 33, 34. Naturally, the latter is only the case once and to the extent that the disturbing event, for example a lateral contact with a microscope objective, is over.

FIG. 8 shows a partial sectional view taken along the line B-B from FIG. 7. FIG. 9 shows a partial sectional view taken along the line B-B, and FIG. 10 shows a partial sectional view taken along the line C-C from FIG. 7.

Furthermore, the exemplary embodiment shown in FIG. 1 comprises a control unit 90 which is able in particular to control the camera 72 and evaluate the measurement data from the latter.

The term “control unit” denotes all hardware and software components which interact with the components of the microscope according to the invention for the intended functionality of the latter. In particular, the control unit may comprise a computing device, for example a PC, and a camera controller. The computer resources of the control unit may be distributed among a plurality of computers and optionally a computer network, in particular also via the Internet. The control unit 90 may have in particular customary operating equipment and peripherals, such as mouse, keyboard, electronic visual display, storage media, joystick, Internet connection. In particular, the control unit may read the image data from the measuring device, for example the camera 72, and also measurement data from actual microscope measurements, and may also serve and be configured for the control of a light source.

In typical exemplary embodiments, the microscope according to the invention comprises a detection beam path and an illumination beam path. Parts of the illumination beam path and the detection beam path may be provided by the same optical components.

The sample 10 may be illuminated using a separate optics unit, in particular via a separate microscope objective. In many arrangements, however, the sample is illuminated by one and the same microscope objective, which is also a constituent part of the detection beam path.

At least one light source may be present for providing the excitation light. The term “illumination beam path” denotes all optical beam guiding and beam modifying components, for example a microscope objective, lenses, mirrors, prisms, gratings, filters, stops, beam splitters, modulators, e.g. spatial light modulators (SLM), by means of which and via which the excitation light from the light source is guided up to and/or into the sample to be examined. Light that is transmitted and/or deflected, for example scattered, by the sample to be examined as a consequence of the irradiation by the excitation light may be referred to as emission light and reaches a detection unit via the detection beam path.

The term “detection beam path” denotes all beam guiding and beam modifying optical components, for example objectives, lenses, mirrors, prisms, gratings, filters, stops, beam splitters, modulators, e.g. spatial light modulators (SLM), by means of which and via which the emission light is guided from the sample to be examined to the detectors. The microscope objective is part of the detection beam path.

Further details of the holding frame 40 are explained in the context of FIG. 12. In the exemplary embodiment shown, the holding frame 40 comprises a substantially rectangular frame 42, which may be formed from anodized aluminium, for example.

As indicated schematically in FIG. 1, the holding frame 40 rests on the sample stage 32 by way of three levelling screws 51, 52, 53. Mechanical means, for example spring clamps, which are not depicted in FIG. 12 may be present on the holding frame 40 for the purpose of attaching and affixing e.g. a microscope slide or a petri dish.

The holding frame 40 extends substantially in a plane, the normal direction of which points approximately in the same direction as a normal direction of a surface of the sample stage 32. A three-point bearing is implemented by the levelling screws 51, 52, 53, and so manual setting of these three levelling screws 51, 52, 53 can bring about an alignment of the holding frame 40 relative to the sample stage 32, and consequently a manipulation of an angle between the normal direction of the plane in which the holding frame 40 extends and the normal direction of the surface of the sample stage 32.

Each of the levelling screws 51, 52, 53 has a marking for the optical detection of their respective rotational position. In the exemplary embodiment shown in FIG. 12, the levelling screws 51, 52, 53 each have markings on their screw heads, from which the rotational position of said levelling screws 51, 52, 53 can be read. The markings are marking elements 61, 62, 63 in the form of marks that extend radially in watch hand-like fashion.

The marking elements 61, 62, 63 are designed such that they can be optically captured by the camera 72. Hence, the camera 72 is configured to indirectly detect the angular position of the holding frame 40 relative to the sample stage 32 by detecting the setting of the setting means, specifically the levelling screws 51, 52, 53. In the shown exemplary embodiment of FIG. 12, the entire travel of the levelling screws 51, 52, 53 is completed within a single rotation, and so ascertainment of the position of the respective marking element 61, 62, 63, and consequently of the respective mark, supplies unambiguous information about the current position of the respective levelling screw 51, 52, 53.

In principle, the user could directly infer the set height of the respective levelling screw visually, i.e. using their eye, from the angular position of the watch hand-like marking elements of the levelling screws 51, 52, 53. However, the visual readout of the setting of the marking elements would be subjective and inaccurate. Hence, use is advantageously made of a measuring device, which is implemented by the camera 72 in the exemplary embodiment of FIG. 1.

Then, by way of the rotational positions of all three levelling screws 51, 52, 53, unambiguous information is available regarding the current alignment of the holding frame 40 relative to the sample stage 30. In the exemplary embodiment shown in FIG. 1, the camera 72 is mounted laterally above the holding frame 40 and is able to simultaneously capture the setting of all three levelling screws 51, 52, 53. However, the camera 72 could also capture markings on the shanks of the levelling screws 51, 52, 53 (see FIG. 13). The data measured by the camera 72 may be transferred to the control unit 90 via a connection not depicted separately in FIG. 1 and may be integrated in an installation space model by the control unit 90. Positions of the marking elements 61, 62, 63 detected by the camera 72 may be processed in the control unit 90 in order to determine a set alignment of the holding frame 40. A calibration of the system may be required. Should all three levelling screws 51, 52, 53 not fit into the field of view of the camera 72 at the same time, the holding frame 40 can be displaced in the x- and/or y-direction relative to the camera 72, for instance by suitable actuation of the xy-displacement stage 30, in order to capture levelling screws 51, 52, 53 that were not in the detection region of the camera 72 in the previous setting of the xy-displacement stage 30. A precondition for this is that the camera is rigidly connected to the stand and not rigidly connected to the displacement stage. In addition to that or in an alternative, a plurality of cameras may also be used.

A restriction of the setting range of the levelling screws to no more than one rotation, i.e. 360°, as in FIG. 1, means that there is a limit to the ratio of achievable accuracy and setting range on account of the setting accuracy of the rotational angle of the levelling screw delimited thereby.

For example, a maximum ratio of 1/12 can be achieved for a division of the circle into twelve positions like in the case of a clock. An adjustment range of +/−0.5° corresponds to a resolution of 5 minutes of arc and thus is at least of the right order of magnitude. However, this is not considered sufficient for many applications. It may therefore be advantageous to extend the setting range of the levelling screws.

The second exemplary embodiment of a microscope according to the invention, as shown schematically in FIG. 11, differs from the exemplary embodiment of FIGS. 1 to 10 in that the restoring forces for the holding frame 40 in the lateral direction are provided by elastic elements 38, which are arranged between a shoulder formed on the sample stage 30 and the holding frame 40. For example, the elastic elements 38 may be formed from foam-like plastics material. In the event of lateral deflections of the holding frame 40 from its intended position relative to the sample stage, the elastic elements 38 deform and press the holding frame 40 back in the direction of its intended position. The defined engagement between the sample stage 30, the elastic elements 38 and the holding frame 40 is lost in the event of lateral deflections that are greater than the respective maximal deflections Δxmax, Δymax, Δzmax, and so the holding frame 40 must be moved manually back into its intended position, and the elastic elements 38 must be brought back into their respective intended arrangement. This also implements the feature whereby, in the event of deflections that are greater than the respective maximal deflections Δxmax, Δymax, Δzmax, restoring forces on the holding frame 40 in the direction of the intended position do not grow with increasing deflection, at least beyond a value range of the respective deflection Δx, Δy, Δz.

A further difference of the exemplary embodiment of FIG. 11 in comparison with FIG. 1 is that the camera 71 tends to view the holding frame 40 and the marking elements 61, 62, 63 of the levelling screws (only shown schematically without reference sign in FIG. 11) directly from above. Markings on the shanks of the levelling screws 51, 52, 53 cannot be detected in this orientation.

Further options in relation to markings of levelling screws are explained in the context of FIG. 13. A levelling screw 50 with a shank 54 and a screw head 56 is shown there. Marking elements 64, 65, 66, 67, which are physically distinguishable in each case, are attached at constant intervals to the edge of the screw head 56 in the example shown. For example, the marking elements 64 to 67 may each have a different colour or mark type. A watch hand-like marking element of the type like the marking elements 61, 62, 63 in FIG. 12 is present at the top of the screw head 56 but not visible in FIG. 13. By observing the marking elements 64 to 67 and/or the watch hand-like marking element (not visible in FIG. 13) at the top of the screw head 56, it is consequently possible to obtain information about a rotational position of the screw 50.

Since the entire travel of the levelling screw 50 is completed over more than one rotation or a plurality of rotations, an evaluation of only the marking elements 64 to 67 and/or of only the watch hand-like marking element on the top side of the screw head 56 would not supply unambiguous information about the rotational position of the levelling screw 50 and hence would not supply unambiguous height information. To counteract this, further marking elements 91 to 95, which need not necessarily be distinguishable, are attached at constant height intervals on the shank 54 of the screw 50. In the example shown, the marking elements 91 to 95 are formed as circumferential rings on the shaft 54. By observing the screw 50 laterally using a camera and by counting the number of rings 91 to 97 which are situated e.g. above the holding frame 40 in a specific position, a unique and accurate statement about the rotational position of the levelling screw 50 relative to a holding frame is also obtained in combination with the information obtained by evaluating the marking elements 64 to 67 and/or the watch hand-like marking element on the top side of the screw head 56.

A third exemplary embodiment of a microscope 300 according to the invention is explained with reference to FIG. 14. The differences in comparison with the exemplary embodiments of FIGS. 1 to 10 and 11 relate to the measuring device for detecting the alignment of the holding frame 40 relative to the sample stage 30. Once again, the holding frame 40 rests on the sample stage 30 by way of manually adjustable contact pins in the form of levelling screws 51, 52, 53; in this respect, this is like the exemplary embodiment of FIGS. 1 to 10. Deviating from the exemplary embodiments described previously, the measuring device of the microscope 300 is configured to directly detect an angular position of the holding frame 40 relative to the sample stage 30. For this purpose, the measuring device comprises a total of three optical sensors 81, 82, 83, which may for example be triangulation sensors or optical sensors that measure a phase offset, said optical sensors in each case measuring a distance to an illuminated point on the holding frame 40. The three points detected by the optical sensors 81, 82 and 83 are not colinear, and so the pose of the plane of the holding frame 40 can be detected unambiguously by the distance measurement using the three optical sensors 81, 82 and 83. Just like the measurement data of the cameras 71, 72 in the exemplary embodiments mentioned previously, the measurement data of the optical sensors 81, 82, 83 may be made available to the control unit 90. The control unit 90 can integrate the measurement data in an installation space model.

For inverted microscopes, the present invention specifies a solution in which system components cannot be damaged in the event of lateral collisions between holding frame and sample on the one hand and objectives on the other hand. This is achieved by virtue of the fact that although collisions are allowed, the maximally arising forces are limited to such an extent that the holding frame, the sample stage, the objectives and the sample carriers, for instance petri dishes or microscope slides, are not damaged in any case. Distance sensors present in the objective may be used for collisions in the axial direction.

For upright microscopes, the present invention provides a partial solution, by means of which at least damage on account of lateral collisions can be avoided.

Since it is not possible to specify a lower limit for the action of force on sensitive biological samples, below which damage is impossible, damage to the biological structure cannot be precluded in the event of sensitive biological samples. In this respect, the invention does not provide a complete solution as regards the avoidance of sample damage but a far-reaching partial solution.

### LIST OF REFERENCE SIGNS

10 Sample
12 Microscope optics unit, microscope objective
14 Eyepiece
16 xy-drive
18 z-drive
20 Microscope stand
22 Collision-free region, range for settings of xy-drive and z-drive, in which collisions between holding frame 40 and other components of the microscope are not possible
23 Inner boundary of collision-free region 22
24 Outer boundary of collision-free region 22
30 Sample stage, xy-displacement stage
31 Opening in sample stage 30, 32
32 Sample stage, xy-displacement stage
33 Dip, mechanical guide for contact pin 51
34 Elongate dip, mechanical guide for contact pin 52
35 Support surface for contact pin
36 Magnet
38 Elastic element, elastic spacer made of foam-like material
40 Holding frame
42 Two-dimensional or three-dimensional range for settings of xy-drive 16 and optionally z-drive 18, in which, based on the model and within the scope of the model accuracy, collisions between holding frame 40 and further components of the microscope are possible but not unavoidable
44 Contour of a region spanned by lateral evasive paths
45 Range for settings of xy-drive 16 and z-drive 18, in which, based on the model and within the scope of the model accuracy, collisions between holding frame 40 and further microscope components are unavoidable
46 Ferromagnetic element on holding frame 40
50 Manually settable contact pin, levelling screw with a magnetic tip or a magnetic support end
51 Manually settable contact pin, levelling screw
52 Manually settable contact pin, levelling screw
53 Manually settable contact pin, levelling screw
54 Shank of levelling screw 50
56 Screw head of levelling screw 50
61 Marking element (mark) on levelling screw 51
62 Marking element (mark) on levelling screw 52
63 Marking element (mark) on levelling screw 53
64 Marking element (mark) at the edge of screw head 56
65 Marking element (mark) at the edge of screw head 56
66 Marking element (mark) at the edge of screw head 56
67 Marking element (mark) at the edge of screw head 56
71 Camera, views holding frame 40 obliquely from above
72 Camera, views holding frame 40 obliquely from above and laterally
81 Optical sensor for detecting a distance from a surface of the holding frame 40
82 Optical sensor for detecting a distance from a surface of the holding frame 40
83 Optical sensor for detecting a distance from a surface of the holding frame 40
90 Control and evaluation unit
91 Marking element on levelling screw 50, circumferential ring on shank 54 of levelling screw 50
92 Marking element on levelling screw 50, circumferential ring on shank 54 of levelling screw 50
93 Marking element on levelling screw 50, circumferential ring on shank 54 of levelling screw 50
94 Marking element on levelling screw 50, circumferential ring on shank 54 of levelling screw 50
95 Marking element on levelling screw 50, circumferential ring on shank 54 of levelling screw 50
100 Microscope according to the invention
200 Microscope according to the invention
300 Microscope according to the invention
A-A Sectional line
B-B Sectional line
C-C Sectional line
SK Nominal disturbance contour, x-axis
y y-axis
Z z-axis
Δx Deflection of the holding frame 40 in x-direction
Δy Deflection of the holding frame 40 in y-direction
Δz Deflection of the holding frame 40 in z-direction
Δxmax Maximal deflection of the holding frame in x-direction, up to which the holding frame 40 is pressed back into the intended position
Δmax Maximal deflection of the holding frame in y-direction, up to which the holding frame 40 is pressed back into the intended position
Δzmax Maximal deflection of the holding frame in z-direction, up to which the holding frame 40 is pressed back into the intended position
Δxn Lateral evasive path in the negative x-direction
Δxp Lateral evasive path in the positive x-direction
Δyn Lateral evasive path in the negative y-direction
Δyp Lateral evasive path in the positive y-direction
Δzp Lateral evasive path in the positive z-direction
δ Shortest distance from a point in the collision-free region 22 to a point outside of collision space 42

1. Microscope comprising:
a microscope stand,
having a microscope optics unit, with an axial spatial direction and two independent lateral spatial directions being defined by an optical axis of the microscope optics unit,
having a sample stage attached to the microscope stand, an xy-drive for moving the sample stage in the lateral spatial directions,
a holding frame serving to hold a sample and arranged on the sample stage, wherein, from an intended position relative to the sample stage, the holding frame is able to take evasive action in the lateral spatial directions, at least via finite-length evasive paths in each case, without damaging pieces that are in contact,
a control unit, at least for controlling the xy-drive, and
an installation space model which is stored in the control unit and in which geometries and positions of the holding frame and of further components of the microscope are in each case at least partially captured as parameters, wherein these parameters and a finite accuracy, with which they are captured in the installation space model, specify a collision space for displacement positions of at least the xy-drive, with collisions of the holding frame with the further components of the microscope being possible in said collision space,
wherein the evasive paths, via which the holding frame can take evasive action in the lateral spatial directions and away from its intended position, are so long that collisions that are between the holding frame and the further components of the microscope and that cause damage to colliding pieces cannot occur at displacement positions of the xy-drive in the collision space.

2. Microscope according to claim 1,
further comprising a z-drive for adjusting an axial distance between the sample stage and the microscope optics unit, wherein the control unit is also configured to control the z-drive,
wherein from its intended position relative to the sample stage, the holding frame is able to take evasive action in the positive direction in the axial spatial direction, at least via a finite-length evasive path, without damaging pieces that are in contact,
wherein the parameters of the installation space model and the finite accuracy, with which they are captured in the installation space model, specify a collision space for the displacement positions of the xy- and the z-drive, with collisions of the holding frame with the further components of the microscope being possible in said collision space, and
wherein the evasive path, via which the holding frame can take evasive action in the positive axial spatial direction and away from its intended position, is so long that collisions that are between the holding frame and further components of the microscope and that cause damage to colliding pieces cannot occur at displacement positions of the z-drive in the collision space.

3. Microscope according to claim 1,
wherein the further components of the microscope, whose geometries and positions are in each case at least partially captured in the installation space model, comprise at least one or more or all of the following components: pieces of the microscope optics unit, pieces of illumination devices, pieces of positioning devices, bearing pieces of the microscope.

4. Microscope according to claim 1,
wherein in the intended position in the two lateral spatial directions, the holding frame is in each case in an at least partially reversible frictional engagement with the sample stage, said frictional engagement being configured to move the holding frame back into the intended position, at least in the event of deflections from the intended position that are in each case smaller than a reversible evasive path, and
wherein in the event of deflections that are greater than the respective reversible evasive paths, restoring forces on the holding frame in the direction of the intended position do not grow with increasing deflection up to the end of the respective evasive path.

5. Microscope according to claim 1,
in that wherein in the intended position in the axial spatial direction, the holding frame is in an at least partially reversible frictional engagement with the sample stage, said frictional engagement being configured to move the holding frame back into the intended position in the event of deflections from the intended position that are smaller than a reversible axial evasive path, and
in that wherein in the event of deflections that are greater than the reversible axial evasive path, restoring forces on the holding frame in the direction of the intended position do not grow with increasing axial deflection up to the end of the axial evasive path.

6. Microscope according to claim 1,
wherein at least one of, a plurality of or all of the lateral evasive paths are longer than half of a respective lateral overall displacement path of the xy-drive and/or
wherein the axial evasive path is longer than half of the axial overall displacement path of the z-drive.

7. Microscope according to claim 1,
wherein at least one of, a plurality of or all of the lateral evasive paths are longer than a respective lateral overall displacement path of the xy-drive and/or
wherein the axial evasive path is longer than the axial overall displacement path of the z-drive.

8. Microscope according to claim 1,
wherein a shortest distance between points in a collision-free region and points outside of the collision space is shorter than each of the lateral evasive paths.

9. Microscope according to claim 1,
in that wherein a shortest distance between points in a collision-free region and points outside of the collision space is shorter than the axial evasive path in the positive axial direction.

10. Microscope according to claim 1,
wherein a shortest distance between a point in a collision-free region and a point outside of the collision space is shorter than each of the reversible evasive paths.

11. Microscope according to claim 1,
wherein the microscope is an inverted microscope.

12. Microscope according to claim 1,
wherein the holding frame rests on the sample stage.

13. Microscope according to claim 1,
in that wherein the holding frame rests on the sample stage via at least one contact pin.

14. Microscope according to claim 1,
in that further comprising magnets for holding the holding frame against the sample stage located on the sample stage and/or on the holding frame.

15. Microscope according to claim 1,
wherein in the event of the intended orientation of the holding frame and of the sample stage relative to the direction of the gravitational force, the gravitational force brings about the partially reversible frictional engagement for at least one coordinate direction.

16. Microscope according to claim 1,
further comprising mechanical devices for creating the frictional engagement with a force driving back into the intended position,
wherein the mechanical devices comprise:
at least one mechanical guide for at least one contact pin; and/or
at least one elastic component that presses the holding frame back into the intended position in the event of deflections from the intended position that are in each case smaller than reversible evasive paths or the reversible evasive paths.

17-18. (canceled)

19. Microscope according to claim 1,
further comprising setting means for setting an alignment of the holding frame relative to the sample stage.

20. Microscope according to claim 19,
wherein the setting means comprise at least one levelling screw.

21. Microscope according to claim 1,
wherein the setting means comprise at least one contact pin.

22. Microscope according to claim 1,
further comprising a measuring device for detecting the alignment of the holding frame relative to the sample stage wherein the measuring device is configured to detect an angular position of the holding frame relative to the sample stage either directly or indirectly by detecting a setting of a setting means for setting an alignment of the holding frame relative to the sample stage.

23-24. (canceled)

25. Microscope according to claim 22,
wherein the measuring device comprises one camera or a plurality of cameras.

26. Microscope according to claim 20,
wherein at least one of the at least one levelling screw has a marking with in each case at least one marking element for the detection of the respective rotational position of said levelling screw.

27. Microscope according to claim 1,
wherein the control unit is configured to output a warning signal if there is a risk of collisions between the holding frame and other components of the microscope.
